(19) United States
(12) Patent Application Publication
(10) Pub. No.: US 2021/0132650 A1
(43) Pub. Date: May 6, 2021

(54) HETEROGENEOUSLY INTEGRATED SILICON PHOTONICS NEURAL NETWORK CHIP

(71) Applicant: Intel Corporation, Santa Clara, CA (US)

(72) Inventors: Wenhua Lin, Fremont, CA (US); Casimir Wierzynski, La Jolla, CA (US); Amir Khosrowshahi, San Diego, CA (US); Bharadwaj Parthasarathy, San Jose, CA (US); Jin Hong, Saratoga, CA (US); Robert Blum, Mountain View, CA (US)

(21) Appl. No.: 16/950,828

(22) Filed: Nov. 17, 2020

(51) Int. Cl. G06E 3/00; G06N 3/067; G02F 1/365

(52) U.S. Cl. CPC G06E 3/005; G06E 3/008; G02F 1/365; G06N 3/0675

(57) ABSTRACT

Embodiments of the present disclosure are directed toward techniques and configurations for a photonics integrated circuit (IC) for an optical neural network (ONN). In embodiments, the photonics IC includes monolithically optoelectronic components in a single semiconductor substrate including a combination of one or more of integrated array of light sources, a plurality of optical modulators, an optical unitary matrix multiplier, non-linear optical amplifiers or attenuators, and a plurality of photodetectors. In embodiments, the optical unitary matrix multiplier comprises a plurality of 2×2 unitary optical matrices optically interconnected, wherein each 2×2 unitary optical matrix comprises a plurality of phase shifters. In embodiments, each 2×2 unitary optical matrix is to phase shift, split, and/or combine one or more of the optical signal inputs. Other embodiments may be described and/or claimed.

### FIELD

Embodiments of the present disclosure generally relate to the field of optoelectronics and more particularly, to techniques and configurations for providing integrated silicon photonics optical devices including optical neural network (ONN) processors.

### BACKGROUND

Machine learning architectures are typically based on artificial neural networks (ANNs) which are inspired by signal processing in the brain. Conventional ANNs rely on electronic components or architectures such as CMOS-related technology. Optical neural networks (ONNs), in contrast, are physical implementation of ANNs that use optical components as building blocks. ONNs built with discrete optical components that can perform ONN functions have begun to emerge. ONNs offer photonic-enabled machine learning (ML) processors that can reach higher than tens to hundreds of Tera-Operations/Second per Watt (TOPS/W) as well as much faster computation speeds, e.g., clock rates larger than 10 Giga-Hertz (GHz) and/or picosecond intrinsic computational speeds. Photonic signal processing may be based on discrete optical components or discrete optical components coupled with a photonic integrated circuit chip.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example top view of a 2×2 unitary directional optical coupler, in accordance with embodiments of the present disclosure.

FIG. 2 illustrates an example top view of a 2×2 unitary adiabatic directional optical coupler, in accordance with embodiments of the present disclosure.

FIG. 3 illustrates an example top view of a plurality of 2×2 unitary directional optical couplers and adiabatic directional optical couplers including one or more common or differential phase shifters, in accordance with embodiments of the present disclosure.

FIG. 4 illustrates a top view of two example 2×2 unitary multi-mode interference (MMI) optical couplers, in accordance with embodiments of the present disclosure.

FIG. 5 illustrates a top view of example 2×2 unitary multi-mode interference (MMI) optical couplers, having one or more of differential phase shifters and/or common phase shifters, in accordance with embodiments of the present disclosure.

FIGS. 6A-6F illustrate top views and cross-sectional views of 2×2 unitary directional optical couplers, in accordance with embodiments of the present disclosure.

FIGS. 7A-7C illustrate top views and cross-sectional views of a 2×2 unitary MMI optical coupler, in accordance with embodiments of the present disclosure.

FIGS. 8A-8C illustrate top views and cross-sectional views of a 2×2 unitary MMI optical coupler, in accordance with another embodiment of the present disclosure.

FIG. 9 illustrates a matrix multiplier that includes a plurality of 2×2 unitary directional optical matrices and an optical unitary matrix that includes a plurality of 2×2 unitary multi-mode interference (MMI) optical couplers, in accordance with other embodiments of the present disclosure.

FIG. 10 is a context diagram that shows a nonlinear optical device within a layer of an ONN, in accordance with various embodiments of the present disclosure.

FIG. 11 is a block diagram of an overview of an integrated photonics device that includes an optical matrix multiplier and a plurality of optoelectronic components, in accordance with embodiments.

FIG. 12 is a block diagram of an integrated photonics device, shown in greater detail, in accordance with some embodiments.

FIG. 13 is a flow diagram which illustrates an example process performed by an integrated photonics device in an optical neural network (ONN), in accordance with various embodiments.

FIG. 14 is a block diagram of an environment including the integrated photonics device, in accordance with embodiments.

FIG. 15 illustrates an example computing device that may include the integrated photonics device of FIGS. 11-14, in accordance with various embodiments.

### DETAILED DESCRIPTION

Embodiments of the present disclosure describe techniques and configurations for an apparatus for an optical neural network (ONN), e.g., a heterogeneously integrated photonics circuit. In embodiments, the apparatus includes a single silicon photonics die or single semiconductor substrate including at least, an array of light sources to generate light signals and an optical unitary matrix multiplier to linearly transform optical signal inputs into optical signal outputs. The optical signal inputs are received from a plurality of optical modulators also integrated into the single semiconductor substrate or the silicon photonics circuit to modulate data onto the optical signals.

In embodiments, the optical unitary matrix multiplier comprises a plurality of 2×2 unitary optical matrices optically interconnected. In embodiments, each 2×2 unitary optical matrix comprises a plurality of phase shifters to phase shift, split, or combine one or more of the optical signal inputs. In embodiments, the apparatus further includes an array of non-linear amplifiers or attenuators to receive the array of optical signal output from the optical unitary matrix multiplier to attenuate or amplify the optical signal outputs and a plurality of photodetectors to receive the attenuated or amplified optical signal outputs. In embodiments, the optical unitary matrix multiplier is the core of an ONN that implements a deep neural network (DNN) of multiple layers that applies weights to perform training and inference operations.

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. It will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

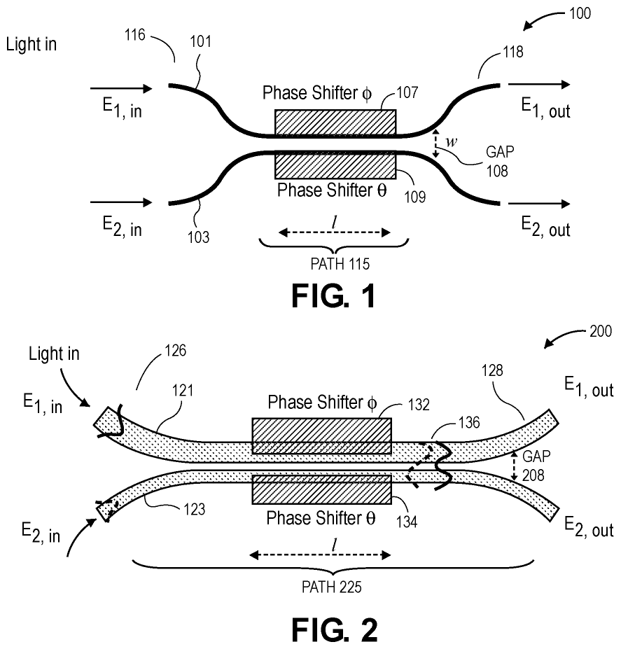

FIG. 1 is illustrates an example top view of a 2×2 unitary directional optical coupler 100 (also referred to as “directional optical coupler 100”), in accordance with embodiments. In embodiments, a configuration of directional optical coupler 100 allows for a 2×2 optical unitary matrix multiplier that is able to perform a 2×2 unitary linear transformation on optical signals in a limited or compact space. As shown, directional optical coupler 100 includes a first optical waveguide 101 and a second optical waveguide 103. First optical waveguide 101 and second optical waveguide 103 are coupled to form a 2×2 optical unitary matrix to receive a respective first input optical signal (e.g., E_{1, in}) and a second input optical signal (e.g., E_{2, in}). As seen from FIG. 1, optical waveguide 101 and 103 form a respective first arm and a second arm that diverge at a first end (e.g., 116) and a second end (e.g., 118) and converge along a middle portion of a path (e.g., path 115). In embodiments, path 115 runs along first optical waveguide 101 and second optical waveguide 103 in a substantially parallel manner. In the embodiment, path 115 includes or integrates a plurality of phase shifters, (e.g., phase shifter 107 and phase shifter 109) to assist in transforming the first optical signal or the second optical signal into a first output optical signal (e.g., E_{1 out}) and second output optical signal (e.g., E_{2 out}) to be output from the 2×2 optical unitary matrix. In embodiments, the transformation includes a combining, splitting, and phase shifting of the first input optical signal and the second input optical signal.

As will be discussed further, in embodiments, phase shifters 107 and 109 include at least one of an electro-optical induced index modulator, thermal-optics induced index modulator, image-spot modulator, or opto-electronic-mechanical modulator, to allow for tunable power at output waveguides. In the embodiment shown, phase shifter 107 applies a first phase shift ø and phase shifter 109 applies a second phase shift θ. As noted previously, in embodiments, directional optical coupler 100 performs a linear unitary transformation via matrix multiplication to input optical signals E_{1,in} and E_{2, in}. For example, the transfer matrix for the directional optical coupler of FIG. 1 can be expressed as:

$$U ( 2 ) = ( \frac{cos ( θ - ∅ )}{tsin ( θ - ∅ )} \frac{tsin ( θ - ∅ )}{cos ( θ - ∅ )} )$$

Note that in embodiments, path 115 has a length of or includes a critical coupling length, l, to allow the unitary transformation of optical signals in optical waveguide 101 and 103. Thus, in the embodiment, 2×2 unitary directional optical coupler 100 includes phase shifters 107 and 109, which may also serve as optical splitters and optical combiners integrated along the critical coupling length l, to respectively split or combine the first input optical signal and/or second input optical signal. In embodiments, critical coupling length l is determined to be a length to, in combination with a width of gap 108, promote or allow the first optical signal to switch from first optical waveguide 101 to the second optical waveguide 103 or vice-versa. Thus, tuning of one or more of the phase shifters causes the first input optical signal or the second input optical signal (or a portion thereof) to be switched into either of the arms to effectively form an analog switch.

As noted above in FIG. 1, optical waveguide 101 and 103 form a respective first arm and a second arm that diverge at a first end (e.g., 116) and a second end (e.g., 118) and converge along a middle portion of a path (e.g., path 115). In embodiments, path 115 is a substantially parallel path along first optical waveguide 101 and second optical waveguide 103. Furthermore, note that path 115 includes a gap 108, having a width w, which runs between first optical waveguide 101 and second optical waveguide 103 along the substantially parallel path. In embodiments, the configuration of the 2×2 optical unitary matrix including the first arm and the second arm that converge to at least a critical coupling length l and gap 108 allow for the matrix multiplication to be performed in a limited or compact space.

Referring now to the embodiment of FIG. 2, which illustrates an example top view of a 2×2 unitary adiabatic directional optical coupler 200 (also sometimes referred to as “adiabatic directional coupler”). In FIG. 2, adiabatic directional optical coupler 200 includes a first optical waveguide 121 and second optical waveguide 123 evanescently coupled to form a 2×2 optical unitary matrix. In embodiments, adiabatic directional optical coupler 200, however, is formed to operate without optical loss or substantially any optical loss. In the embodiments shown, adiabatic directional optical coupler 200 is formed to include optical waveguides that have dissimilar widths, core dimensions, or bend diameters, from each other and/or that vary in their widths or diameters along a length of an optical path that includes a plurality of phase shifters, e.g., phase shifter 132 and 134. In the embodiment, adiabatic directional optical coupler 200 receives a respective first input optical signal (e.g., E_{1,in}) and a second input optical signal (e.g., E_{2, in}) and outputs a respective first output optical signal (e.g., E_{1 out}) and second output optical signal (e.g., E_{2 out}). As shown, optical waveguide 121 and optical waveguide 123 converge to run alongside each other to direct the first input optical signal and the second input optical signal along optical path 225 (“path 225”). In embodiments, path 225 may include a critical coupling length, l, that may be longer or shorter than path 225, but that promotes adiabatic evanescent coupling between optical signals in optical waveguide 121 and 123.

As noted above and as shown in FIG. 2, first optical waveguide 121 has a different width, core dimension, or bend diameter, from second optical waveguide 123. Furthermore, in some embodiments, the width of one or more of first optical waveguide 121 and second optical waveguide 123 varies along path 225. Accordingly, adiabatic directional optical coupler 200 includes a first optical waveguide 121 separated from a second optical waveguide 123 by a gap 208. In embodiments, gap 208 varies in width along path 225 due to varying width of first optical waveguide 121 or second optical waveguide 123. In embodiments, gap 208 includes a width that in addition to a critical coupling length l, is determined to promote evanescent coupling (e.g., at 136) between a first input optical signal and second input optical in first optical waveguide 121 and second optical waveguide 123.

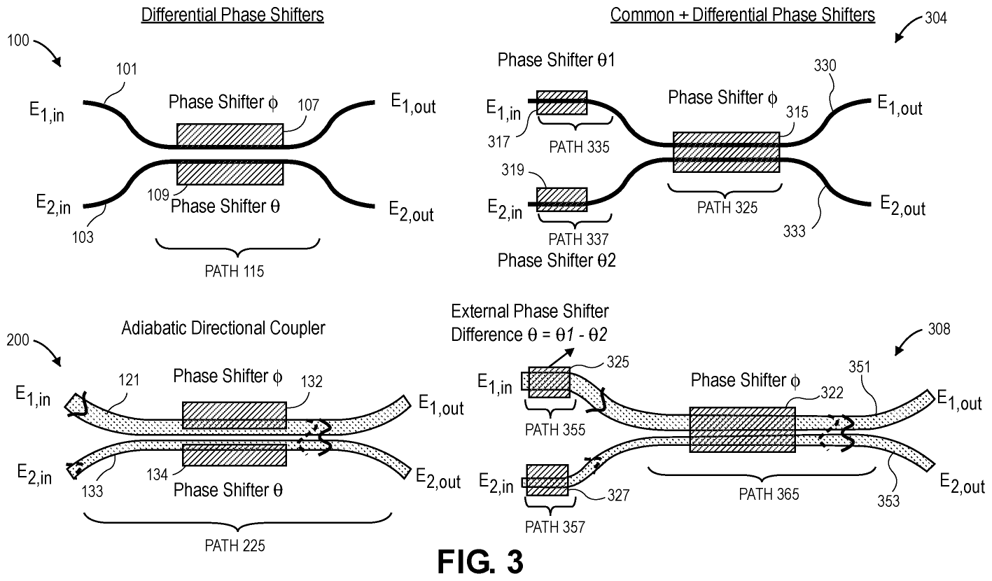

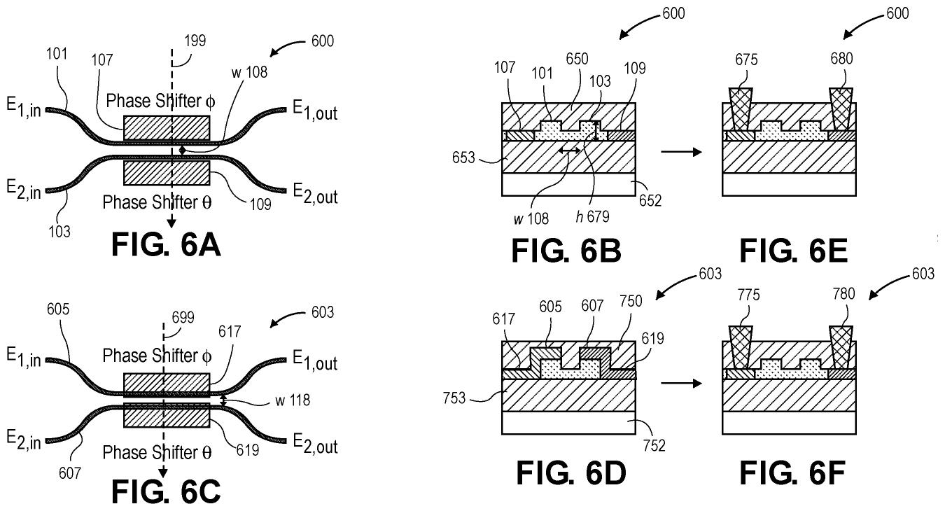

As seen in FIG. 2, optical waveguides 121 and 123 form a respective first arm and a second arm that diverge at a first end (e.g., 126) and a second end (e.g., 128) and converge along a middle portion of a substantially parallel path (e.g., path 225). Note optical waveguides 121 and 123 form a concave up or concave down shape. Note that as shown and discussed in connection with FIGS. 3 and 6 below, it is understood that a type and number of phase shifters in directional optical coupler 100 and adiabatic directional optical coupler 200 will vary.

FIG. 3 illustrates an example top view of a plurality of 2×2 unitary directional optical couplers and adiabatic directional optical couplers including one or more common or differential phase shifters, in accordance with embodiments. On a left side of FIG. 3, directional coupler 100 and adiabatic directional coupler 200 as described above in FIGS. 1 and 2 are reproduced. Note that directional coupler 100 and adiabatic directional coupler 200 include differential phase shifters. For example, unitary directional optical coupler 100 includes phase shifter 107, which applies a phase shift ø, and phase shifter 109, which applies a phase shift θ, to apply a differential phase shift (e.g., phase shift ø−phase shift θ). Similarly, adiabatic directional coupler 200 includes phase shifters 132 and phase shifter 134 to apply a differential phase shift (phase shift ø−phase shift θ) to a first input optical signal (e.g., E_{1,in}) and a second input optical signal (e.g., E_{2, in}) of adiabatic directional coupler 200.

In contrast, directional optical coupler 304 and adiabatic directional optical coupler 308 on a right side of FIG. 3 include both differential phase shifters and a common or single phase shifter that is common to both optical waveguides. As shown, directional optical coupler 304 includes a first optical waveguide 330 and a second optical waveguide 333. Common phase shifter 315 is located or integrated on a path common to each of first optical waveguide 330 and second optical waveguide 333. In contrast, external phase shifters 317 and 319 are located on paths 335 and 337 that are external to a path 325 that integrates common phase shifter 315, which implements a unitary transformation of the 2×2 unitary matrix. In the example embodiment, external phase shifters 317 and 319 of directional optical coupler 304 together apply a differential phase shift of phase shift θ1−phase shift θ2.

Similarly, in embodiments, adiabatic directional coupler 308 includes a first optical waveguide 351 and a second optical waveguide 353 including a common phase shifter 322. Common phase shifter 322 is located or integrated on a path common to each of first optical waveguide 351 and second optical waveguide 353. In contrast, external phase shifters 325 and 327 are located on paths 355 and 357 that are external to a path 365 that integrates common phase shifter 322, which implements a unitary transformation. In embodiments, external phase shifter 325 applies phase shift θ1 while external phase shifter 327 applies a phase shift of θ2 to together apply a differential phase shift of θ1−θ2.

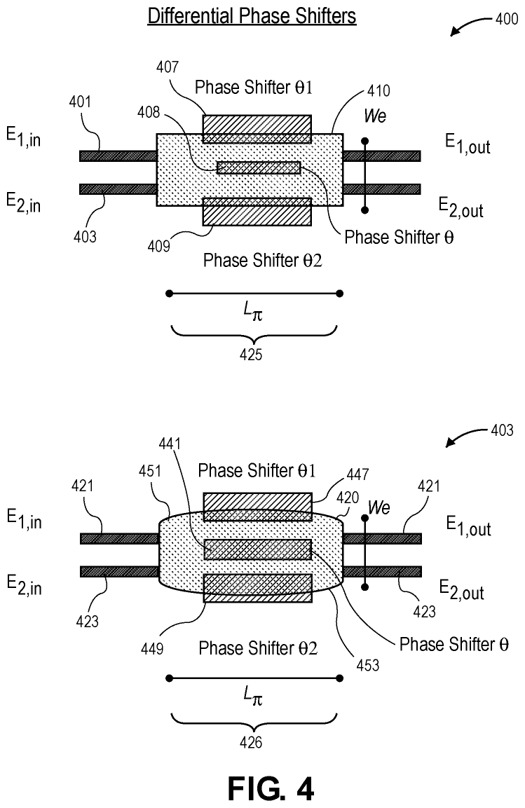

Referring now to FIG. 4, which illustrates a top view of two example 2×2 unitary multi-mode interference (MMI) optical couplers, in accordance with embodiments. In FIG. 4, each of unitary MMI optical coupler 400 and a unitary MMI optical coupler 403 include respective multi-mode (MMI) waveguide structures 410 and 420 that intersect an optical path. In embodiments, the MMI waveguide structures are formed such that modes of a first optical signal and modes of a second optical signal interfere with each other to assist in performing a unitary transformation of input optical signals. Note that unitary MMI optical coupler 400 and unitary MMI optical coupler 403 are similar to each other, with the exception of a differing shape of a bowed shape of MMI waveguide structure 420 of unitary MMI optical coupler 403.

As shown, unitary MMI optical coupler 400 includes a first optical waveguide 401 and a second optical waveguide 403 coupled to form a 2×2 optical unitary matrix to receive a respective first input optical signal (e.g., E_{1 in}) and a second input optical signal (e.g., E_{2 in}). In embodiments, MMI waveguide structure 407 has a length Lπ and a width Wₑ. Optical waveguide 401 and optical waveguide 403 run alongside each other to direct the first input optical signal and the second input optical signal along an optical path 425 that intersects with MMI waveguide structure 410 for length Lπ. In the embodiment, optical path 425 includes or integrates a plurality of phase shifters to assist in performing a unitary transformation of the first optical signal and/or the second optical signal into a first output optical signal (e.g., E₁ₒᵤₜ) and second output optical signal (e.g., E_{2 out}). In the embodiment, MMI optical coupler 400 includes phase shifter 407, phase shifter 408, and phase shifter 409 along length Lit.

Similarly, unitary MMI optical coupler 403 includes a first optical waveguide 421 and a second optical waveguide 423 coupled to form a 2×2 optical unitary matrix to receive a respective first input optical signal (e.g., E_{1 in}) and a second input optical signal (e.g., E_{2 in}). In the embodiment, optical path 426 includes or integrates a plurality of phase shifters to assist in performing a unitary transformation of the first optical signal or the second optical signal into a first output optical signal (e.g., E₁ₒᵤₜ) and second output optical signal (e.g., E₂ₒᵤₜ) to be output from the 2×2 optical unitary matrix. In the embodiment, MMI optical coupler 403 includes phase shifter 447, phase shifter 441, and phase shifter 449 along length Lπ.

In embodiments, MMI waveguide structure 420 has a length Lπ and a width Wₑ. Optical waveguide 421 and optical waveguide 423 run alongside each other to direct the first input optical signal and the second input optical signal along an optical path 426 that intersects with MMI waveguide structure 420 for length Lπ. As noted above, MMI waveguide structure 420 has a differing shape than MMI waveguide structure 410. In the embodiment shown, MMI waveguide structure 420 has a curved or bowed shape along lengthwise perimeters 451 and 453. In embodiments, the curved or bowed shape provides additional space to allow interference of the modes of the first optical input signal and a second optical input signal.

Note that, in embodiments, length Lπ of MMI optical couplers 400 and 403 includes a fraction or a multiple of a critical beating length Lc of the two lowest order modes, with a multiple of a phase shifter combination for optimal phase shift efficiency. For example, if width Wₑ is a width of MMI optical couplers 400 or 403, βo is the propagation foundation of the foundational mode, β1 is the propagation constant of a first order mode, nᵣ is the effective refractive index of an optical waveguide, e.g., MMI waveguide structure 407 or 420, and λo is the wavelength of the light, then:

$${L}_{c} = \frac{π}{{β}_{0} - {β}_{1}} \approx \frac{4 {n}_{r} {W}_{e}^{2}}{{β}_{0} - {β}_{1}}$$

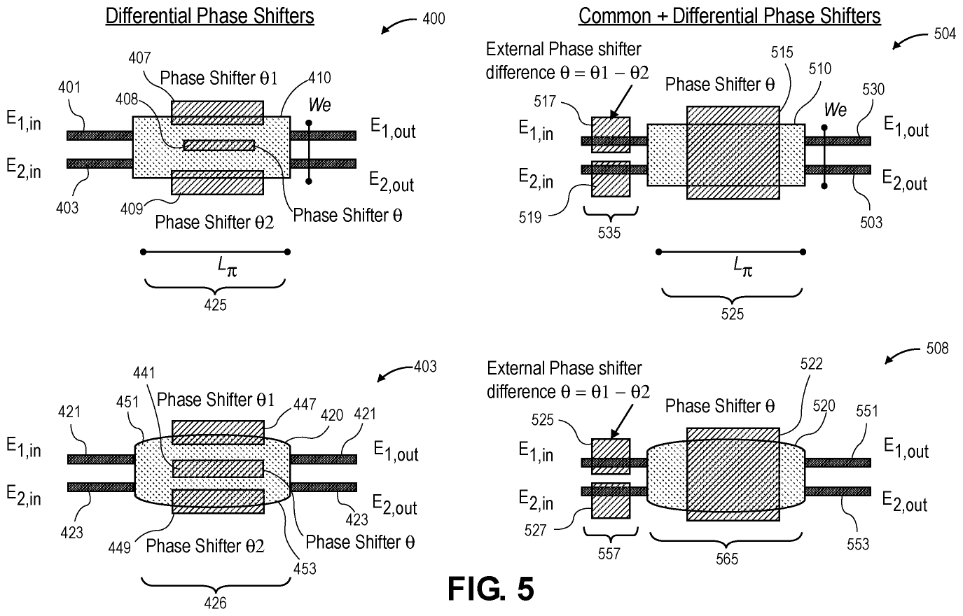

Note that, although MMI optical coupler 400 and 403 each include three phase shifters, it is understood that in other embodiments, the MMI optical couplers include any suitable number of phase shifters or arrangements of phase shifters to phase shift the first input optical signal and/or the second input optical signal to perform a unitary transformation. In some examples, MMI optical couplers includes successive phase shifters along the optical path that includes length Lπ. In some examples, the MMI optical couplers also include a combination of both common phase shifters and differential phase shifters as will be shown in FIG. 5. In embodiments, modes of the first optical signal and the second optical signal interfere in the MM waveguide to output an optical signal at a power ratio that can be adjusted according to unitary matrix algebra.

FIG. 5 illustrates a top view of example 2×2 unitary multi-mode interference (MMI) optical couplers, having differential phase shifters and/or common phase shifters. Unitary MMI optical couplers 400 and 403 of FIG. 4, whose elements were shown and described in connection with FIG. 4, are reproduced on a left column of FIG. 4. Thus, unitary MMI optical coupler 400 includes phase shifter 407 and phase shifter 409 to apply a differential phase shift (e.g., phase shift ø1−phase shift ø2). Similarly, MMI optical coupler 403, having curved MMI waveguide structure 420, includes phase shifters 447 and 449 to apply a differential phase shift (phase shift ø1−phase shift ø2) on its respective first optical waveguide and second optical waveguide. Each of MMI optical coupler 400 and 403 also include respective phase shifters 408 and 441 to apply a phase shift θ.

Unitary MMI optical couplers 504 and 508 on a right side of FIG. 5 include elements similar to or the same as unitary MMI optical couplers 400 and 403. In contrast to unitary MMI optical couplers 400 and 403, however, unitary MMI optical couplers 504 and 508 have differential phase shifters located external to their respective waveguide structures 510 and 520. In embodiments, the differential phase shifters are located or integrated on an external path (e.g., 535 and 557) optically coupled to the respective 2×2 unitary matrices. Unitary MMI optical couplers 504 and 508 each include a common phase shifter integrated within or on waveguide structures 510 and 520. In embodiments, common phase shifters 515 and 522 are located in or integrated on substantially an entire optical path along respective waveguide structures 510 and 520. In contrast, external phase shifters (517, 519 and 525, 527) are located on paths 535 and 557 that are external to optical paths 525 and 565 of respective waveguide structures 510 and 520. Note that, in embodiments, due to having both common and differential phase shifters, unitary directional optical coupler 100 may be tuned with differential and common phase control modes.

FIGS. 6-8 illustrate top and cross-sectional views of various embodiments of example 2×2 unitary directional optical couplers and 2×2 unitary MMI optical couplers. Note that in embodiments, the optical couplers are formed in crystalline silicon. Examples of waveguide materials include but are not limited to silicon, a thin silicon layer in SOI (silicon on insulator), glass, oxides, nitrides, e.g., silicon nitride, polymers, semiconductors or other suitable materials. In embodiments, waveguides in the optical couplers described in the FIGS. may be made of any medium that propagates a wavelength of light and surrounded with a cladding with a lower index of refraction. In some embodiments, waveguides may be formed on a buried oxide layer (BOX) layer of an SOI wafer with a top cladding layer over the waveguides. In embodiments, the top cladding layer includes silicon dioxide (SiO₂) having an index of refraction of n=1.45, while a silicon-based waveguide has an index of refraction of, e.g., n=3.48. In embodiments, the optical couplers are formed via known lithography/etch methods associated with formation of optical waveguides on SOI wafers.

FIGS. 6A-6F illustrate top and cross-sectional views of example 2×2 unitary directional optical couplers, in accordance with embodiments of the present disclosure. FIG. 6A illustrates unitary directional optical coupler 600 which is the same or similar as unitary directional optical coupler 100 shown and described in FIG. 1 (for brevity, description of some similar elements are not repeated). In embodiments, a dotted arrow 199 represents a plane through which a cross-section of unitary directional optical coupler 600 is shown in FIG. 6B. As shown, in FIG. 6B, first optical waveguide 101 and second optical waveguide 103 are single mode optical waveguide structures formed over a buried oxide layer (BOX) 653 on a silicon on insulator (SOI) wafer 652. In the embodiment, a top cladding layer 650 is formed over first optical waveguide 101 and second optical waveguide 103. In the embodiment, phase shifter 107 and phase shifter 109 are formed to abut or nearly abut respective first optical waveguide 101 and second optical waveguide 103 but do not cover first optical waveguide 101 and second optical waveguide 103. In embodiments, an example width w of a gap 108 between waveguides 101 and 103 is 0.2-0.8 micrometers (μm). In the example of FIG. 6A, first optical waveguide 101 and second optical waveguide 103 have heights of 0.2-0.4 μm (e.g., element 679 in FIG. 6B). Note that these widths and heights are only examples and any suitable heights or widths that are consistent with providing 2×2 unitary directional optical couplers with phase shifters to perform the unitary transformation are contemplated.

In some embodiments, after formation of phase shifters 107 and 109, metal connections to control a tuning of the phase shifters using known methods are implemented. For example, various method include, but are not limited to, processes that include, e.g., resistive thin-film strip (doped silicon, SiN) or metal wire (TiW, Tungsten) as thermal phase shifters, or doped P+ regions and doped N+ regions to form p-i-n junctions as electro-optical phase shifters. For example, FIG. 6E illustrates unitary directional optical coupler 600 after metal connections 675 and 680 are formed (note that similar or same elements have not been labeled for clarity in the FIGS), using known methods such as passivation layer (typical oxide layer, SiN) deposition, and pad openings for metal contacts and connections 675 and 680. In various embodiments, metal connections 675 and 680 may include wire bonding, bump pads, or other suitable connections, coupled to allow a tunability of phase shifters 107 and 109. In embodiments, electro-optic tuning of phase shifters 107 and 109 control application of weights being applied in matrix multiplication in the unitary transformation.

In an embodiment, shown in FIG. 6C, is another unitary directional optical coupler 603. As shown, unitary directional optical coupler 603 includes a phase shifter 617 and phase shifter 619 that cover at least a top portion of first optical waveguide and a second optical waveguide 605 and 607. In embodiments, a dotted arrow 699 represents a plane through which a cross-section of unitary directional optical coupler 603 is shown to the right of optical coupler 603 in FIG. 6D. As shown, phase shifters 617 and 619 are formed over a buried oxide layer (BOX) 753 over a silicon on insulator (SOI) wafer 752. A top cladding layer 750 is shown above phase shifters 617 and 619. As noted above, phase shifters 617 and 619 are formed to cover at least a portion of respective first optical waveguide 605 and second optical waveguide 607.

After formation of phase shifters 617 and 619, metal connections to control a tuning of the phase shifters are formed. For example, FIG. 6F illustrates unitary directional optical coupler 603 after metal connections 775 and 780 are formed (note that similar or same elements have not been labeled for clarity in the FIGS). In various embodiments, metal connections 775 and 780 may include wire bonding, bump pads, or other suitable connections, to allow a tunability of phase shifters 617 and 619.

In embodiments, phase shifter 107 and phase shifter 109 of FIG. 6A are PN-diode-based phase shifters or thermal based phase shifters. Note that in other embodiments, phase shifters 617 and 619 of FIG. 6C may cover varying portions of first optical waveguide 605 and second optical waveguide 607.

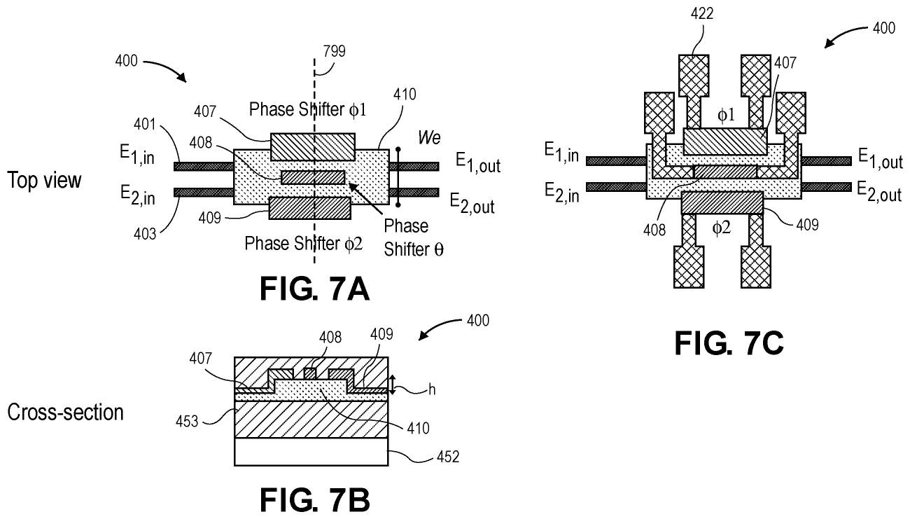

FIGS. 7A-7C illustrate top and cross-sectional views of a 2×2 unitary MMI optical coupler, in accordance with embodiments of the present disclosure. FIGS. 7A-7C illustrate embodiments associated with methods of forming phase shifters of a unitary MMI optical coupler. FIG. 7A illustrates a unitary MMI optical coupler similar to as shown and described in FIG. 4 (note that description of similar elements may not be repeated). In embodiments a dotted arrow 799 represents a plane through which a cross-section of unitary MMI optical coupler 400 is shown in FIG. 7B. As seen in FIG. 7B, unitary MMI optical coupler 400 is formed over a buried oxide layer (BOX) 453 on a silicon on insulator (SOI) wafer 452. In embodiments, phase shifters 407 and 409 are formed to cover at least a portion of MMI waveguide structure 410. In some embodiments, MMI waveguide structure 410 is a waveguide that is wide compared to, e.g., first optical waveguide 401 and second optical waveguide 403, and includes a width Wₑ of, for example, 2-10 μm and a height h of 0.2-0.4 μm. In the embodiment, additional phase shifter 408 is formed over (or integrated above) MMI waveguide structure 410. After formation of the phase shifters, metal connections to control a tuning of the phase shifters are formed. For example, FIG. 7C illustrates MMI optical coupler 400 after metal connections 422 are formed. In various embodiments, metal connections 422 may include wire bonding or bump pads coupled to tunable phase shifters of MMI optical coupler 400. Although six metal connections are shown, only metal connection 422 is labeled for clarity in the FIGS.

Note that an electro-optical tuning applied through the metal connections allows the modes of the first optical signal and the second optical signal to interfere in the MM waveguide to output an optical signal at a power ratio that can be adjusted according to U(2) matrix algebra.

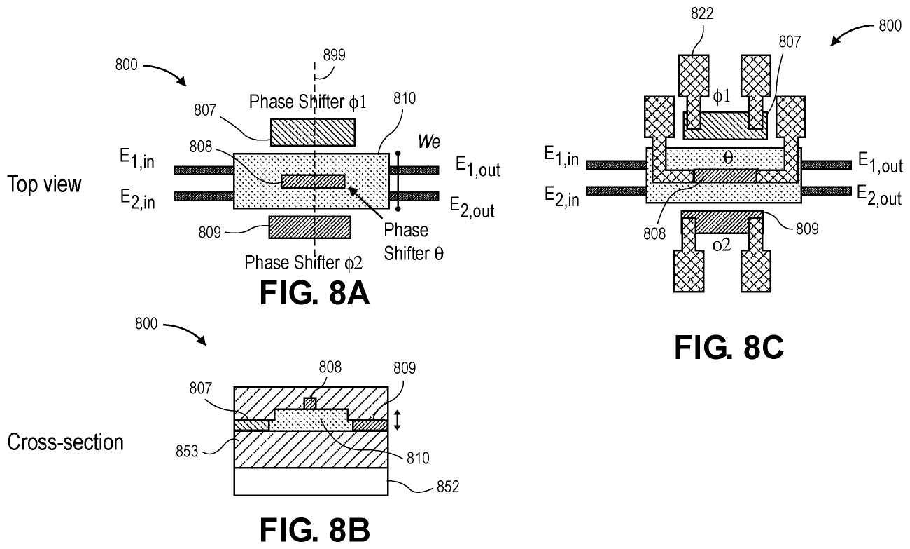

FIGS. 8A-8C illustrate top views and cross-sectional views of another 2×2 unitary MMI optical coupler, in accordance with another embodiment of the present disclosure. FIGS. 8A-8C are associated with a method of forming phase shifters in a unitary MMI optical coupler. FIG. 8A shows a top view of a unitary MMI optical coupler similar to that of FIGS. 7A-7C and FIG. 4, with the exception that a first and a second phase shifter are formed next to MMI waveguide structure 810 (rather than covering a portion of MMI waveguide structure 810). In FIG. 8A, a dotted arrow 899 represents a plane through which a cross-section of a unitary MMI optical coupler 800 is shown in FIG. 8B. As seen in FIG. 8B, unitary MMI optical coupler 800 is formed over a buried oxide layer (BOX) 853 on a silicon on insulator (SOI) wafer 852. In embodiments, phase shifters 807 and 809 are formed next to MMI waveguide structure 810. In the embodiment shown, a third, or additional, phase shifter 808 is formed over (or integrated above) MMI waveguide structure 810.

After formation of the phase shifters, metal connections to control a tuning of the phase shifters 807 and 809 are formed. For example, FIG. 8C illustrates unitary MMI optical coupler 800 after metal connections 822 are formed. In various embodiments, metal connections 822 may include wire bonding or bump pads coupled to tunable phase shifters 807, 808, and 809 of MMI optical coupler 800. Although six metal connections are shown, only metal connection 822 is labeled for clarity in the FIGS.

Note that phase shifters 407, 409 and 807, 808, and 809 of FIGS. 7A and 8A may include any suitable type of phase shifter such as, but not limited to, PN-junction diode phase shifters or thermal heater phase shifters. Furthermore, as noted previously, a number and configuration of phase shifters may vary. For example, in various embodiments, a plurality of phase shifters may be integrated on MMI waveguide structure 410 or 810 in a successive arrangement (not shown).

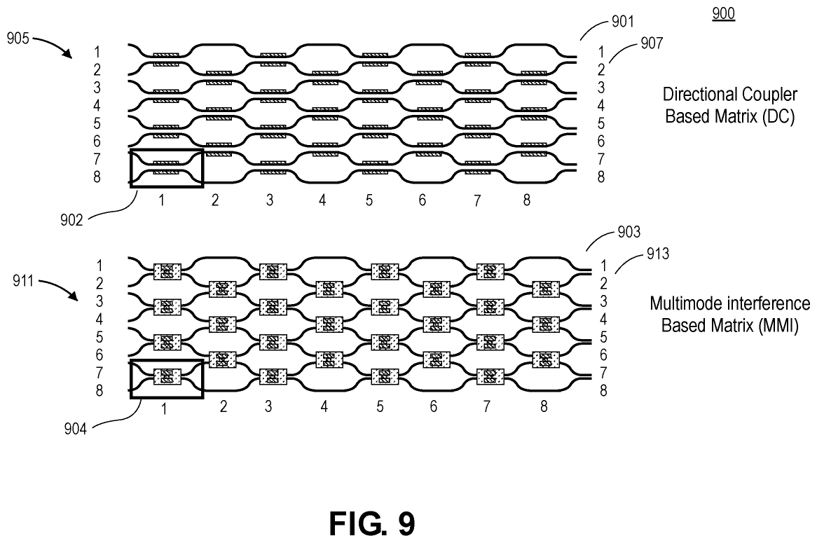

FIG. 9 illustrates examples of a first matrix multiplier and a second matrix multiplier having a plurality of optical unitary matrices coupled together. In embodiments, the unitary optical matrices are coupled together to form matrix multipliers having a plurality of n optical inputs and a plurality of n optical outputs. In embodiments, the plurality of 2×2 unitary optical matrices are optically coupled to receive an array of optical signal inputs and to linearly transform the plurality of optical signal inputs into an array of optical signal outputs, wherein each of the plurality of 2×2 unitary optical matrices include a first optical waveguide and a second optical waveguide coupled to converge and diverge along an optical path.

In embodiments, matrix multiplier 901 is a larger unitary optical matrix that includes a plurality of 2×2 unitary directional optical matrices 902 (e.g., similar or the same as directional optical coupler 100 of FIG. 1), while matrix multiplier 903 includes a plurality of 2×2 unitary multi-mode interference (MMI) optical couplers 904 (e.g., similar or the same as the example 2×2 unitary (MMI) optical couplers of FIG. 4). Note that for clarity in the FIG., only one of 2×2 directional optical matrices 902 (e.g., 2×2 directional optical coupler 100 of FIG. 1) and one of 2×2 unitary MMI optical couplers 904 is labeled. For matrix multiplier 901, a plurality of 2×2 directional optical matrices 902 are optically coupled together to receive an array of optical signal inputs at 905 in FIG. 8 and to linearly transform the plurality of optical signal inputs into an array of optical signal outputs 907. Similarly, for matrix multiplier 903, a plurality of unitary MMI optical couplers 904 are coupled together to receive an array of optical signal inputs at 911 to linearly transform the plurality of optical signal inputs into an array of optical signal outputs 913.

Note that in various embodiments, the matrix multipliers include any of, or any suitable combination of, different types of 2×2 optical matrices, such as the 2×2 unitary directional optical couplers and 2×2 unitary MMI optical couplers as described and shown in previous FIGS. 1-8. For example, in various embodiments, the matrix multipliers include a plurality of 2×2 unitary adiabatic directional optical couplers such as the 2×2 unitary adiabatic directional optical coupler of FIG. 2, 2×2 unitary directional optical couplers and adiabatic directional optical couplers having one or more common or differential phase shifters of FIG. 3, or 2×2 unitary multi-mode interference (MMI) optical couplers having one or more of differential phase shifters and/or common phase shifters of FIG. 5.

Note that the array of optical signal inputs 905 for matrix multiplier 901 (and optical signal inputs 911 for matrix multiplier 903) include n optical inputs and n optical signal outputs where n=8. In embodiments, the matrix multipliers each include n (n−1)/2 2×2 unitary optical matrices (e.g., n (n−1)/2 2×2 optical matrices). Although n=8 in FIG. 9 for both matrix multiplier 901 and 903, it should be understood that 8 is only an example and n is any number of optical inputs and optical outputs suitable for an application. In embodiments, n is 2, 4, 8, 16, 32, 64, 128, or 256. It is further understood that couplings as in matrix multiplier 901 and 903 have been simplified in order to conceptually illustrate optical connections between 2×2 directional optical matrices 902 or unitary multi-mode interference (MMI) optical couplers 904. The matrix multiplier can have n optical inputs and m output outputs, n may be not equal to m where n, m=2, 3, 8, 16, 32, 64, 128 or 256, and the matrix multiplier includes n (m−1)/2 2×2 unitary optical matrices.

Accordingly, as described in connection with FIGS. 2-8, each of 2×2 directional optical matrices 902 and 2×2 unitary multi-mode interference (MMI) optical couplers 904 each include a first optical waveguide and a second optical waveguide coupled along an optical path. Furthermore, for the embodiments, a plurality of tunable optical phase shifters (e.g., as described in connection with FIGS. 1-8) are included along the optical path of each of the first optical waveguide and the second optical waveguide in each of the plurality of 2×2 unitary optical matrices to phase shift an optical beam to linearly transform the array of optical signal inputs into the array of optical signal outputs.

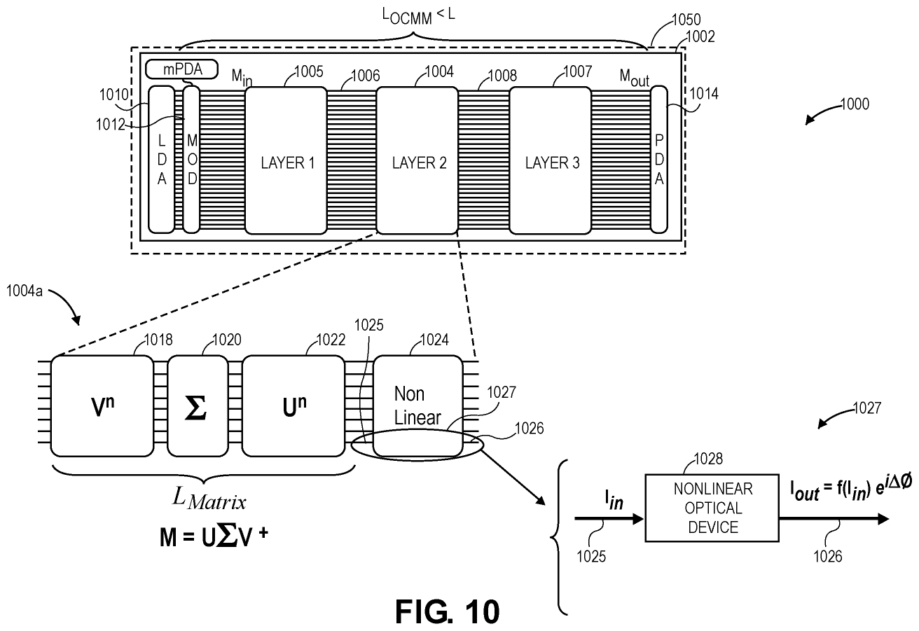

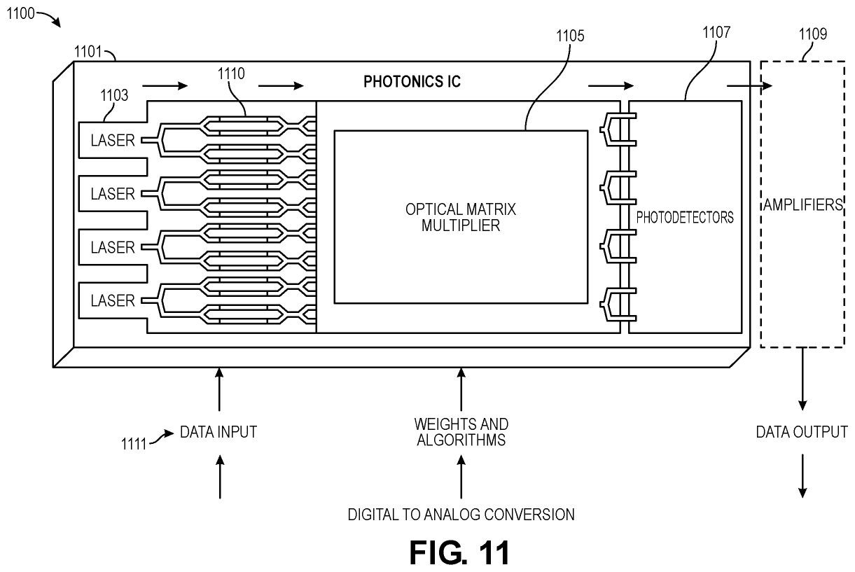

FIG. 10 is a context diagram that shows a nonlinear optical device within a layer of an ONN included on a photonics integrated circuit (PIC) as will be discussed in connection with FIGS. 11-17, in accordance with various embodiments. In embodiments, the ONN includes one or more layers each including a plurality of optical unitary matrix multipliers followed by optical nonlinear optical devices implementing a nonlinearity function. Integrated photonic device 1000 shows an ONN 1002 that includes one or more layers 1004 having multiple optical signal inputs 1006 and multiple optical signal outputs 1008. In this example, each layer 1004 has 32 optical signal inputs 1006 and 32 optical signal outputs 1008. In other embodiments the number of optical signal inputs 1006 or optical signal outputs 1008 may vary. In embodiments, the ONN 1002 may be provided as an integrated circuit on the integrated photonic device 1000.

Within the ONN 1002, a laser diode array (LDA) 1010 together with optical modulators 1012 (hereinafter referred to as “modulator 1012”) provides optical input to a first layer 1005. A photodetector array 1014 will receive optical output from the third layer 1007, and convert that output into digital signals. In this example, light signals are sent from layer 1 1005, to layer 2 1004, and then to layer 3 1007. Each layer is made up of an optical unitary matrix multiplier (that may include a plurality of optical unitary matrix multipliers) and non-linear optical devices (e.g., nonlinear optical amplifiers 1024 described below). In embodiments, the ONN 1002 including array (LDA) 1010, modulator 1012, multiple layers 1005, 1004, 1007, and PDA 1014 can be implemented in a heterogeneously integrated photonics circuit, such as a single silicon photonics die or single semiconductor substrate 1050.

Diagram 104a shows various components of the optical unitary matrix multiplier unit within layer 2 1004, which includes three optical unitary matrix multipliers 1018, 1020, 122 that are composed of a plurality of optical unitary matrices (e.g., matrix multipliers including 2×2 unitary directional optical couplers and/or 2×2 unitary MMI optical couplers as described and shown in previous FIGS. 1-9). As shown, the light signals flow out of the Uⁿ optical unitary matrix multiplier 1022 and into a plurality of nonlinear optical devices 1024 for each layer 1004.

Nonlinear optical amplifiers 1024 may be needed to be coupled to the optical unitary matrix multiplier 1022 due to the linear nature of the optical signal processing from the optical unitary matrix multipliers 1018, 1020, 1022. The optical signal, including noise added to the optical signal, may be linearly increased during operation of the ONN 1002, and may result in a final signal intensity from the Uⁿ optical unitary matrix multiplier 1022 that is too high. This signal intensity may cause optical inputs to overload a subsequent layer 1007, or overload the PDA 1014.

The nonlinear optical amplifier 1024 may comprise multiple nonlinear optical devices. An example nonlinear optical device 1028 is shown in FIG. 10 to the right of the layer 1004 (blown-up area 1027 of the nonlinear amplifier 1024). An optical input signal 1025 into the device 1028 may be transformed into an optical output signal 1026 of a particular nonlinear optical device 1028 shown with respect to area 1027. The term “amplifier” is used in a broad sense here. The input signal 1025 may need to be amplified in a linear way, amplified in a non-linear way, as well as saturated and attenuated, and/or otherwise “cleaned up” in order for the resulting optical signal output 1026 to be more distinguishable. Other functions may include light rectifying and saturating for the resulting optical signal output for high classification and predication in the ONN layers. These functions are explained further in reference to FIG. 2.

The equation I out=f(Iᵢₙ)e^{iΔϕ} on the output of 1026 shown in FIG. 10 defines the overall optical signal input to optical signal output nonlinear activation function, where f is the optical intensity function of nonlinear optical device 1028 as a function of optical signal input power Iᵢₙ; and Δϕ is the phase change from optical signal input to optical signal output generated by the non-linear optical device 1028. The intensity function f includes optical amplifying, saturating, rectifying and attenuating, and/or a combination of these functions, or any types of similar function to serve as optical input to optical output nonlinear activation functions. In embodiments, a few criteria are to be met with respect to nonlinear optical device 1028. First, the optical nonlinear activation may need active feedback control to emulate the arbitrary layers matrices and to classify and predict performance. Examples of active control are bias current, voltage and/or phase tuning operation for activation functions in optical amplifying, attenuating and saturating. Second, low electrical power consumption in each optical nonlinear device is typically determined by the biasing current times the biasing voltage applied on the nonlinear optical device 1028, and it is desired to reach power efficiency in ONNs. Third, various optical nonlinear functions f can be implemented in the optical domain with associated IC driver and firmware algorithms, similar to various CMOS IC-based nonlinear functions.

For example, if the signal output 1026 level represents 8 bits, it may be desirable for the nonlinear optical device 1028 to clean up the representation of a low bit to 0, and a high bit to be put into the upper limits as a saturation function. This will enhance the performance of optical signal output to proceed to the next layer in the linear functions of the various optical matrix multipliers.

In embodiments, the nonlinear optical device provides optical amplification to compensate for waveguide propagation loss needed to emulate the multiple layers of the ONN. In embodiments, a III-V gain medium is bonded to silicon photonics to provide amplification, where the gain medium has both linear and nonlinear amplification functions when input power reaches a saturation level. The amplification function may include a multi-quantum well medium to increase efficiency. In embodiments, a carrier-injection pin diode can be added to couple with the amplification function to provide light attenuation control to not overload the subsequent layer or photodiode array (PDA).

FIG. 11 is a block diagram of an overview of an integrated photonics device 1100 that includes an optical matrix multiplier and a plurality of optoelectronic components, in accordance with embodiments. As shown, integrated photonics device 1100 includes an array of light sources, such as, e.g., lasers 1103 in a semiconductor substrate, e.g., silicon substrate 1101, to generate an array of light signals or optical signals (e.g., light intensity signals). In embodiments, lasers 1103 include any suitable light source such as, e.g., lasers or hybrid lasers (e.g., hybrid bonded lasers on a silicon photonic chip including, e.g., silicon substrate 1101) such as indium phosphide (InP) lasers. In the embodiment, a plurality of optical modulators 1110 are coupled to lasers 1103 to receive the array of optical signals and modulate data onto the optical signals to generate an array of optical signal inputs. In embodiments, data (as will be discussed in further detail in connection with FIGS. 2-4) is input to plurality of optical modulators 1110 (e.g., see 1111). Note that as shown in FIG. 11, optical modulators 1110 are shown as Mach-Zehnder interferometers, however, other suitable optical modulators are contemplated (e.g., optical ring modulators, or . . . ). In embodiments, after modulation, optical modulators 1110 provide a plurality of optical signal inputs to optical matrix multiplier 1105 integrated in silicon substrate 1101. As shown in connection with e.g., FIGS. 1-9, optical unitary matrix multiplier 205 includes a plurality of 2×2 unitary optical matrices optically interconnected. In the embodiment, optical unitary matrix multiplier 1105 performs matrix multiplication to linearly transform the plurality of optical signal inputs into an array or plurality of optical signal outputs.

As shown, an array or plurality of photodetectors 1107 (“photodetectors 1107”) (such as but not limited to, e.g., waveguide photodetectors, avalanche photodetectors) are coupled to detect the plurality optical signal outputs (“optical signal outputs”). As will be shown in connection with FIG. 2, in embodiments, non-linear optical devices that optically amplify or attenuate (e.g., see FIG. 10 and accompanying description) are coupled to amplify or attenuate optical signal outputs prior to being detected by photodetectors 1107. Photodetectors 1107 convert optical signal outputs to photocurrent. In embodiments, electronic amplifiers 1109 are coupled to photodetectors 1107 to receive photocurrent from the outputs of photodetectors 1107 to further amplify the electrical signal outputs. In embodiments, electronic amplifiers 1109 include, for example, transimpedance amplifiers (TIAs), which are located in or on integrated photonics device 1100 or coupled to integrated photonics device 1100 (as shown in FIG. 11).

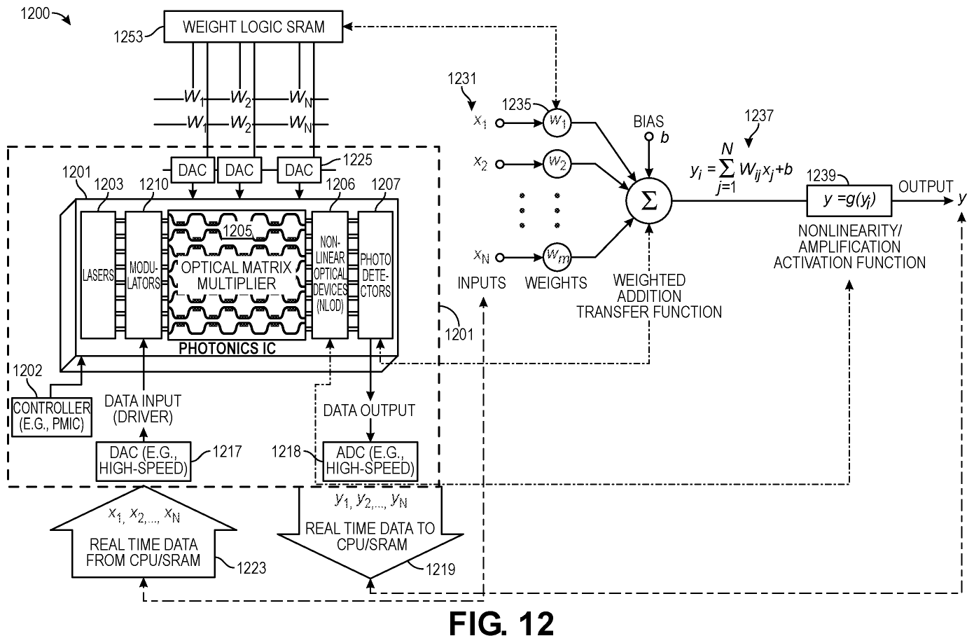

FIG. 12 is a block diagram of an integrated photonics device 1201, shown in greater detail, in accordance with some embodiments. As shown, array of light sources or lasers 2003 are coupled to plurality of optical modulators 2010 (“optical modulators 1210”), which provide optical signal inputs to optical matrix multiplier 1205 integrated in silicon substrate 1201. In FIG. 12, a controller 1202 is coupled to lasers 1203. In some embodiments, controller 1202 controls drivers for both lasers 1203 and optical modulators 1210. In some examples, controller 1202 is included in a power management integrated circuit (PMIC). In embodiments, data is input into optical modulators to 1210 via digital to analog converter circuitry (DAC) 1217. In embodiments, DAC 1217 receives real-time data at 1223 from a data pipeline provided to integrated photonics device 1201. In embodiments, the data pipeline is included in electronic support circuitry for integrated photonics device 1201, which together with integrated photonics device 1201 forms an optical accelerator. Note that electronic support circuitry will be discussed further in connection with FIG. 4.

As noted above, an optical matrix multiplier 1205 includes a plurality of 2×2 optical unitary matrices optically interconnected (shown and described in connection with FIGS. 1-9) to perform a unitary transformation on the optical signals. As shown and described in connection with FIGS. 1-8, each 2×2 unitary optical matrix comprises a plurality of phase shifters to phase shift, split, or combine one or more of the optical signal inputs. In embodiments, each 2×2 unitary optical matrix comprises a weight to be applied in the ONN and each of the phase shifters of each 2×2 unitary optical matrix is electro-optically tuned to assist in applying the weight. In embodiments, a memory 1253 (e.g., a weight logic Static Random Access Memory (SRAM)) is coupled to provide DAC 1225 with weights 1253 for optical matrix multiplier 1205. In embodiments, the weights are provided to DAC 1225 via a link (e.g., low speed) from a CPU or electronic support circuitry coupled to the CPU.

As shown in FIG. 12, another DAC 1217 provides high speed analog data to optical modulators 1210. In embodiments optical modulators 1210 are high-speed optical modulators which modulate the data onto the optical input signals. As noted in connection with FIG. 1, optical modulators 1210 may include any suitable type of optical modulators which can modulate data onto light signals at high speed, such as for example, but not limited to, Mach-Zehnder interferometer modulators or optical ring modulators.

As shown DAC 1217 receives real-time data at 1223 to be input to optical matrix multiplier 1205. Real-time data includes, for example inputs (see 1231), e.g., x₁, x₂ . . . x_{N}. For example, in embodiments, for an N×M matrix, modulators 1210 encode an N-dimensional input vector (hereinafter “vector”) of x₁, x₂ . . . x_{N}, into an array of optical signal inputs. In embodiments, the array of optical signal inputs is treated as a vector and optical unitary matrix multiplier 1205 functions as the matrix to multiply the vector to generate optical signal outputs or vector-matrix multiplication product. For example, in a linear ONN (e.g., 2-layer ONN), a response neuron yᵢ is a vector-matrix multiplication product where a neuron xⱼ is included in vector [symbol] and Wᵢⱼ is a connect weight in a matrix [symbol] from neuron xⱼ onto response neuron yᵢ by: [symbol] =

[symbol]

In an example N×M matrix, vector-matrix multiplication is shown as:

$${( \begin{matrix}{y}_{1} \\ {y}_{2} \\ ⋮ \\ {y}_{M}\end{matrix} )}_{( M \times 1 )} = {( \begin{matrix}{W}_{11} & {W}_{12} & ⋯ & {W}_{1 N} \\ {W}_{21} & {W}_{22} & ⋯ & {W}_{2 N} \\ ⋮ & ⋮ & & ⋮ \\ {W}_{M 1} & {W}_{M 2} & ⋯ & {W}_{MN}\end{matrix} )}_{( M \times N )} {( \begin{matrix}{x}_{1} \\ {x}_{2} \\ ⋮ \\ {x}_{N}\end{matrix} )}_{( N \times 1 )}$$

In embodiments, a transfer function including weighted addition (as shown at 1237) in FIG. 12, for response neuron yᵢ is:

$${y}_{1} = {\sum }_{i = 1}^{N} {W}_{1 f} {x}_{f} + b$$

In embodiments, after optical unitary matrix multiplier 1205 linearly transforms the plurality of optical signal inputs into an array of optical signal outputs, the optical signal outputs are amplified (or attenuated) by non-linear optical devices (NLODs) at 1206. In embodiments, applying a non-linear transfer function (e.g., applied by NLODs 1206) is shown at 1239 (also 1219) in FIG. 12, results in an output y.

y=g(yᵢ) or

y=g(Σⱼ₌₁^{N}w_{i,j}xᵢ+b)

where g is a function defined by a gain medium or other non-linear functions (e.g., as described in connection with FIG. 10) and bias b is an additive bias vector. As noted above, although the example provided is a 2-layer ONN, note that any suitable number of layers appropriate for a DNN are contemplated. For example, a typical number of layers for a DNN may be 5-1000 layers.

After the application of the non-linear functions, the optical signals are then detected by photodetectors 1207 and further amplified by electrical amplifiers 109 (as shown in FIG. 1). In embodiments, data (e.g., y₁, y₂ . . . yₙ) is then output at 1215 as high speed analog data to analog-to-digital conversion (ADC) circuitry or ADC 1218. In embodiments, output data is then transmitted as real-time data 1219 over a link (e.g. high-speed link) to electronic support circuitry to be returned to the data pipeline and proceed through another cycle, e.g., inference cycle (predictive) of an ONN model being applied, as will be discussed in more detail below.

Note that optical unitary matrix multiplier 1205 may include an optical unitary matrix unit that includes, e.g., three optical unitary matrix multipliers (e.g., to perform singular value decomposition). In embodiments, the optical unitary matrix unit in combination with the NL optical amplifiers or attenuators may form one layer of the DNN.

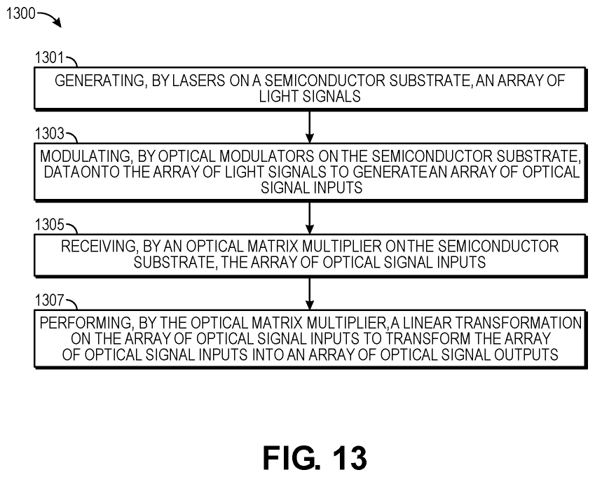

FIG. 13 is a flow diagram which illustrates an example process 1300 performed by an integrated photonics device performing matrix multiplication in an optical neural network (ONN), in accordance with various embodiments. In embodiments, the integrated photonics device includes not only an optical matrix multiplier (including, e.g., a plurality of 2×2 unitary optical matrices optically interconnected) but light sources, optical modulators, NLODs, and photodetectors, as shown in FIGS. 11 and 12. The process 1300 may start at a block 1301. At a block 1301, process 1300 includes generating by a plurality of light sources (e.g., lasers 1103 of FIG. 11) on a semiconductor substrate, an array of light signals. Next, process 1300 includes modulating on the semiconductor substrate, data onto the array of light signals to generate an array of optical signal inputs at 1303. In embodiments, the optical modulators then provide the modulated optical signal inputs to the optical unitary matrix multiplier. Thus, at a block 1305, process 1300 includes receiving, by and optical matrix multiplier on the semiconductor substrate, the array of optical signal inputs. At a next block 1307, process 1300 includes performing, by the optical matrix multiplier, a linear transformation on the array of optical signal inputs to transform the array of optical signal inputs into an array of optical signal outputs. Note that in embodiments, performing, by the optical matrix multiplier, the linear transformation includes performing the linear transformation using a plurality of 2×2 unitary optical matrices optically interconnected, wherein each 2×2 unitary optical matrix comprises a plurality of phase shifters to phase shift one or more of the optical signal inputs. In embodiments, the plurality of 2×2 unitary optical matrices include directional couplers and MMI couplers (such as shown and described in connection with FIGS. 1-9).

In embodiments, process 1300 further includes receiving the array of optical signals output from the optical unitary matrix multiplier and performing an optical nonlinear amplification or attenuation optical signal outputs (not shown) by, e.g., NLODs 1206 of FIG. 12. In embodiments, as described in connection with FIGS. 11 and 12, process 1300 may further includes providing the amplified photo current to ADC circuitry to convert the optical signals to electrical signals.

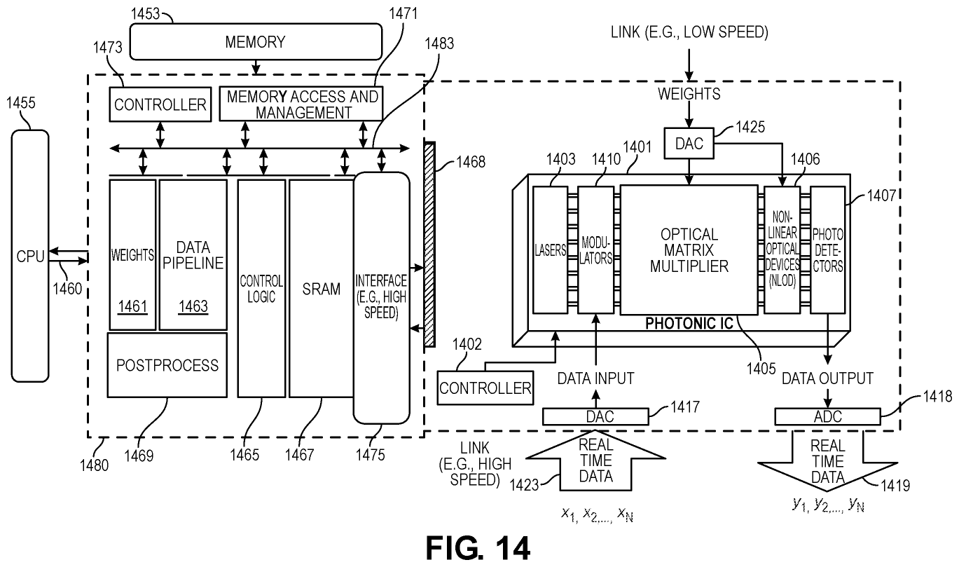

Referring now to FIG. 14, which is a block diagram of an integrated photonics device 1401 coupled to an electronic circuitry 1480, according to embodiments. Integrated photonics device 1401 is similar or the same as integrated photonics device 1201 of FIG. 12. Electronic circuitry 1480 is coupled to integrated photonics device 1401 via radiofrequency (RF) and DC routing interconnections 1468 (e.g., an interconnect bridge or other multi-die interconnection structure). Note that in some examples, electronic circuitry 1480 includes a programmable circuit, however, in various embodiments, certain elements of electronic circuitry 1480 are also incorporated together or as discrete elements in different combinations with integrated photonics device 1201. In embodiments, electronic circuitry 1480 may be a programmable circuit, e.g., an ASIC or an FPGA. In the embodiment, electronic circuitry 1480 is coupled to a CPU 1455 (e.g., Xeon™ CPU) and a memory 1453. In some embodiments, memory 1453 includes, e.g., a Double Data Rate Synchronous Dynamic Random-Access Memory (DDR SDRAM) or any suitable memory capable of high-data rate transfer memory associated with CPU 1455. Electronic circuitry 1480 includes elements for weights 1461, a data pipeline 1463, control logic 1465, post-processing unit 1469, a shared memory (e.g., SRAM) 1467, and a high-speed interface 1475. Various elements also include a CPU control 1473 and memory access and management units 1471. In some embodiments, memory access and management units 1471 include e.g., a Direct Memory Access unit (DMA) and/or a memory management unit (MMU). In embodiments, memory access and management units 1471 transfer data to and from memory 1453 and/or data pipeline 1463 (e.g., activation buffers and the like included in data pipeline 1463) as needed.

In FIG. 14, CPU 1455 is coupled to electronic circuitry 1480 via an input/output (I/O) bus 1460. In embodiments, memory 1453 (e.g., similar or the same as weight logic SRAM 253 of FIG. 12) provides weights, e.g., initial training weights, staged weights, reuse weights, as well as instructions to be implemented by control logic 1465. In embodiments, memory 1453 is coupled to provide a DAC 1425 (shown at top of integrated photonics device 1401) with weights for optical matrix multiplier 1405 via a low speed link. In embodiments, data incoming from CPU 1455 (e.g., data values associated with machine learning applications, e.g., speech recognition, computer vision, multimedia, and the any suitable machine learning application) to be analyzed by an inference or predictive model of an ONN is provided by CPU 1455 via I/O bus 1460 (e.g., latest generation of PCI-e or other high speed bus) to join data pipeline 1463. In embodiments, data pipeline 1463 provides DAC 1417 with real-time data at 1423 via interface 1475 that is to be input to optical matrix multiplier 1405 via optical modulators 1410. Real-time data includes, for example inputs, e.g., x₁, x₂ . . . x_{N}, as discussed in connection with FIG. 12.

In embodiments, similar to optical modulators 1210 of FIG. 12, for an N×M matrix, optical modulators 1410 encode an N-dimensional input vector (“vector”) of x₁, x₂, . . . x_{N} into the array of optical signal inputs. Optical unitary matrix multiplier 1405 applies the weights input by DAC 1425 by matrix multiplication, resulting in a unitary transformation on the optical signals. Note that the ONN may include multiple hidden layers. Note that in various embodiments, the ONN includes not only a feed-forward neural network but recurrent neural networks as well. Optical unitary matrix multiplier 1405 then provides optical output signals to non-linear optical devices (NLODs) 1406, amplifiers and attenuators, for non-linear transformation. In embodiments, photodetectors 1407 then detect the optical signal outputs and convert the optical signal outputs to photo current. In embodiments, the photocurrent is amplified by electrical amplifiers 1109 (e.g., TIAs), and then the signal is provided to analog to digital converter 1418.

Accordingly, in embodiments ADC 1418 converts the optical signal outputs (“outputs”), e.g. y₁, y₂, . . . y_{N}, (e.g., see 1419 in FIG. 14) to electrical signals as real time data that are returned via a high speed link to electronic circuitry 1480. In embodiments, the outputs may be provided to data pipeline 1463, undergo post-processing at post-process 1469, and returned to CPU 1455 for next steps. In embodiments, e.g., during a training model where weights are being updated, the cycle may be repeated until weighted output errors associated with a set of data (such as training data) are sufficiently reduced.

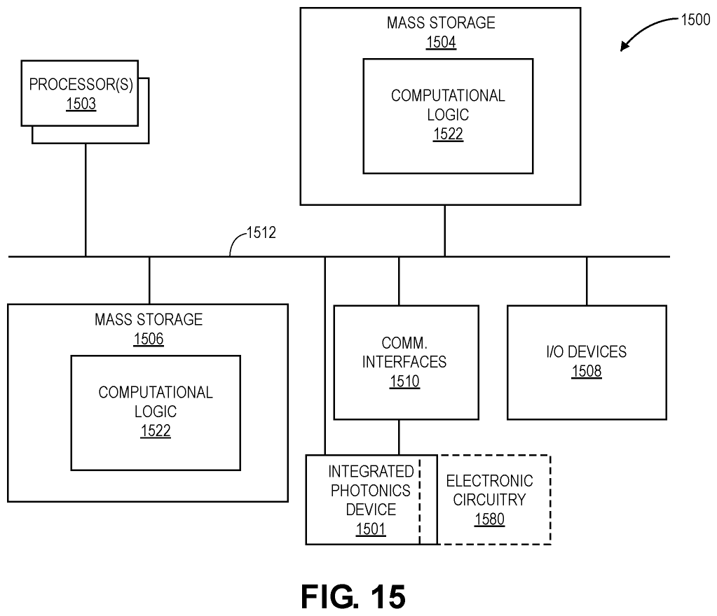

FIG. 15 illustrates an example computing device 1500 suitable for use with an integrated photonics device 1501 (e.g., similar to or the same as integrated photonics devices 102, 1201, and 1401 of respective FIGS. 11, 12, and 14) and electronic support circuitry 1580 (e.g., similar or the same as electronic circuitry 1480 of FIG. 14), in accordance with various embodiments as described herein. In embodiments, integrated photonics device 1501 includes an optical neural network (ONN) integrated circuit (IC) including an array of light sources and an optical unitary matrix multiplier in a semiconductor substrate. In embodiments, the array of light sources generates an array of light signals and integrated photonics device 1501 further includes an integrated plurality of optical modulators to receive the array of light signals and modulate data onto the array of light signals and provide optical signal inputs to the optical unitary matrix multiplier. In embodiments, the optical unitary matrix multiplier linearly transforms the plurality of optical signal inputs into an array of optical signal outputs. In embodiments, a processor coupled to the ONN IC provides the ONN with the data to modulate onto the array of optical signal inputs to be transformed by the optical unitary matrix multiplier.

For example, as shown, computing device 1500 may include a one or more processors or processor cores 1503 and memory 1504. In embodiments, memory 1504 may be system memory. For the purpose of this application, including the claims, the terms “processor” and “processor cores” may be considered synonymous, unless the context clearly requires otherwise. The processor 1503 may include any type of processors, such as a central processing unit (CPU, e.g., CPU 1455 of FIG. 14), a microprocessor, and the like. The processor 1503 may be implemented as an integrated circuit having multi-cores, e.g., a multi-core microprocessor. The computing device 1500 may include mass storage devices 1506 (such as diskette, hard drive, volatile memory (e.g., dynamic random-access memory (DRAM), compact disc read-only memory (CD-ROM), digital versatile disk (DVD), and so forth). In general, memory 1504 and/or mass storage devices 1506 may be temporal and/or persistent storage of any type, including, but not limited to, volatile and non-volatile memory, optical, magnetic, and/or solid state mass storage, and so forth. Volatile memory may include, but is not limited to, static and/or dynamic random-access memory. Non-volatile memory may include, but is not limited to, electrically erasable programmable read-only memory, phase change memory, resistive memory, and so forth. In embodiments, memory 1504 includes, e.g., memory 143 of FIG. 14.

The computing device 1500 may further include input/output (I/O) devices 1508 (such as a display (e.g., a touchscreen display), keyboard, cursor control, remote control, gaming controller, image capture device, and so forth) and communication interfaces 1510 (such as network interface cards, modems, infrared receivers, radio receivers (e.g., Bluetooth), and so forth). In some embodiments, the communication interfaces 1510 may include or otherwise be coupled with integrated photonics device 1501, as described above, in accordance with various embodiments.

The communication interfaces 1510 may include communication chips that may be configured to operate the device 1500 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long-Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 1510 may operate in accordance with other wireless protocols in other embodiments.

The above-described computing device 1500 elements may be coupled to each other via system bus 1512, which may represent one or more buses. In the case of multiple buses, they may be bridged by one or more bus bridges (not shown). Each of these elements may perform its conventional functions known in the art. In particular, memory 1504 and mass storage devices 1506 may be employed to store a working copy and a permanent copy of the programming instructions for the operation of integrated photonics device 1501 and electronic support circuitry 1580. The various elements may be implemented by assembler instructions supported by processor(s) 1503 or high-level languages that may be compiled into such instructions.

The permanent copy of the programming instructions may be placed into mass storage devices 1506 in the factory, or in the field, through, for example, a distribution medium (not shown), such as a compact disc (CD), or through communication interface 1510 (from a distribution server (not shown)). That is, one or more distribution media having an implementation of the agent program may be employed to distribute the agent and to program various computing devices.

The number, capability, and/or capacity of the elements 1508, 1510, 1512 may vary, depending on whether computing device 1500 is used as a stationary computing device, such as a server computer in a data center, or a mobile computing device, such as a tablet computing device, laptop computer, game console, or smartphone. Their constitutions are otherwise known, and accordingly will not be further described.

For one embodiment, at least one of processors 1503 may be packaged together with computational logic 1522 configured to practice aspects of optical signal transmission and receipt described herein to form a System in Package (SiP) or a System on Chip (SoC).

In various implementations, the computing device 1500 may comprise one or more components of a data center, a laptop, a netbook, a notebook, an ultrabook, a smartphone, a tablet, a personal digital assistant (PDA), an ultra mobile PC, a mobile phone, or a digital camera. In further implementations, the computing device 1500 may be any other electronic device that processes data.

According to various embodiments, the present disclosure describes a number of examples.

Example 1 may include an apparatus for an optical neural network (ONN), comprising: an array of light sources in a semiconductor substrate to generate an array of light signals; a plurality of optical modulators coupled to the array of light sources in the semiconductor substrate to modulate data onto the array of light signals to generate an array of optical signal inputs; and an optical unitary matrix multiplier coupled to the plurality of optical modulators in the semiconductor substrate to receive the array of optical signal inputs from the plurality of optical modulators and to linearly transform the plurality of optical signal inputs into an array of optical signal outputs, wherein the semiconductor substrate is a single semiconductor substrate and the array of light sources, the plurality of optical modulators, and the optical unitary matrix multiplier are heterogeneously integrated in the single semiconductor substrate.

Example 2 includes the apparatus of Example 1, wherein the optical unitary matrix multiplier includes a plurality of 2×2 unitary directional optical couplers, plurality of 2×2 unitary multi-mode interference (MMI) optical couplers, or combination thereof.

Example 3 includes the apparatus of Example 1, wherein the optical unitary matrix multiplier comprises a plurality of 2×2 unitary optical matrices optically interconnected, wherein each 2×2 unitary optical matrix comprises a plurality of phase shifters to phase shift, split, or combine one or more of the optical signal inputs.

Example 4 includes the apparatus of Example 1, further comprising an array of non-linear optical devices to receive the array of optical signal outputs from the optical unitary matrix multiplier to attenuate or amplify the optical signal outputs.

Example 5 includes the apparatus of Example 1, further comprising an array of photodetectors coupled to detect the attenuated or amplified optical signal outputs and provide the attenuated or amplified optical signal outputs to an analog to digital converter (ADC).

Example 6 includes the apparatus of Example 3, wherein each 2×2 unitary optical matrix comprises a weight to be applied in the ONN and wherein each of the phase shifters of each 2×2 unitary optical matrix is tuned to assist in applying the weight.

Example 7 includes the apparatus of Example 6, wherein the optical unitary matrix multiplier is to receive the weight from a digital analog converter (DAC).

Example 8 includes a method for an optical neural network (ONN), comprising: generating, by a plurality of light sources on a semiconductor substrate, an array of light signals; modulating, by a plurality of optical modulators on the semiconductor substrate, data onto the array of light signals to generate an array of optical signal inputs; receiving, by an optical unitary matrix multiplier on the semiconductor substrate, the array of optical signal inputs; and performing, by the optical unitary matrix multiplier, a linear transformation on the array of optical signal inputs to transform the array of optical signal inputs into an array of optical signal outputs, wherein the semiconductor substrate is a single semiconductor substrate including the plurality of light sources, optical unitary matrix multiplier, and optical unitary matrix multiplier.

Example 9 includes the method of Example 8, wherein the performing, by the optical unitary matrix multiplier, the linear transformation includes performing the linear transformation using a plurality of optically interconnected 2×2 unitary optical matrices, wherein each optically interconnected 2×2 unitary optical matrix comprises a plurality of phase shifters to phase shift one or more of the optical signal inputs.

Example 10 includes the method of Example 9, wherein the plurality of 2×2 unitary optical matrices include 2×2 unitary directional optical couplers or 2×2 unitary multi-mode interference (MIMI) optical couplers.

Example 11 includes the method of Example 10, wherein modulating, by the plurality of optical modulators, the data includes encoding an N-dimensional input vector of inputs into an array of optical signal inputs.

Example 12 includes the method of Example 8, further comprising receiving, by a non-linear device, the array of optical signals output from the optical unitary matrix multiplier and performing an optical nonlinear amplification or attenuation of optical signal outputs.

Example 13 includes the method of Example 12, further comprising providing the amplified or attenuated optical signal outputs to an analog-to-digital converter (ADC).

Example 14 includes a system, comprising: an optical neural network (ONN) integrated circuit (IC), comprising: an array of light sources in a semiconductor substrate to generate an array of light signals; a plurality of optical modulators coupled to receive the array of light signals from the array of light sources in the semiconductor substrate and to modulate data onto the array of light signals to provide optical signal inputs to the optical unitary matrix multiplier; and an optical unitary matrix multiplier optically coupled to the plurality of optical modulators in the semiconductor substrate to receive the array of optical signal inputs and to linearly transform the plurality of optical signal inputs into an array of optical signal outputs; and a processor coupled to the ONN IC to provide the ONN with the data to modulate onto the array of optical signal inputs to be linearly transformed by the optical unitary matrix multiplier.

Example 15 includes the system of Example 14, wherein the semiconductor substrate is a single semiconductor substrate and the array of light sources, the plurality of optical modulators, and the optical unitary matrix multiplier are monolithically integrated in the single semiconductor substrate.

Example 16 includes the system of Example 14, wherein the optical unitary matrix multiplier comprises a plurality of 2×2 unitary optical matrices optically interconnected, wherein each 2×2 unitary optical matrix comprises a plurality of phase shifters to phase shift, split, or combine one or more of the optical signal inputs.

Example 17 includes the system of Example 14, further comprising electronic circuitry coupled to the optical unitary matrix multiplier and including a memory device and control logic to form an ONN accelerator coupled to receive the data from the processor.

Example 18 includes the system of Example 14, further comprising an array of non-linear optical amplifiers and attenuators integrated in the semiconductor substrate to receive the array of optical signal output from the optical unitary matrix multiplier to attenuate or amplify the optical signal outputs.

Example 19 includes the system of Example 14, further comprising an array of photodetectors coupled to detect the attenuated or amplified optical signal outputs and provide the attenuated or amplified optical signal outputs to an analog to digital converter.

Example 20 includes the system of any one of Examples 14-19, wherein the processor coupled to the ONN IC is included data center server computing device.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations, including what is described in the Abstract, is not intended to be exhaustive or to limit the embodiments of the present disclosure to the precise forms disclosed. While specific implementations and examples are described herein for illustrative purposes, various equivalent modifications are possible within the scope of the present disclosure, as those skilled in the relevant art will recognize.

These modifications may be made to embodiments of the present disclosure in light of the above detailed description. The terms used in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

What is claimed is:

1. An apparatus for an optical neural network (ONN), comprising:
an array of light sources in a semiconductor substrate to generate an array of light signals;
a plurality of optical modulators coupled to the array of light sources in the semiconductor substrate to modulate data onto the array of light signals to generate an array of optical signal inputs; and
an optical unitary matrix multiplier coupled to the plurality of optical modulators in the semiconductor substrate to receive the array of optical signal inputs from the plurality of optical modulators and to linearly transform the plurality of optical signal inputs into an array of optical signal outputs, wherein the semiconductor substrate is a single semiconductor substrate and the array of light sources, the plurality of optical modulators, and the optical unitary matrix multiplier are heterogeneously integrated in the single semiconductor substrate.

2. The apparatus of claim 1, wherein the optical unitary matrix multiplier includes a plurality of 2×2 unitary directional optical couplers, plurality of 2×2 unitary multi-mode interference (MMI) optical couplers, or combination thereof.

3. The apparatus of claim 1, wherein the optical unitary matrix multiplier comprises a plurality of 2×2 unitary optical matrices optically interconnected, wherein each 2×2 unitary optical matrix comprises a plurality of phase shifters to phase shift, split, or combine one or more of the optical signal inputs.

4. The apparatus of claim 1, further comprising an array of non-linear optical devices to receive the array of optical signal outputs from the optical unitary matrix multiplier to attenuate or amplify the optical signal outputs.

5. The apparatus of claim 1, further comprising an array of photodetectors coupled to detect the attenuated or amplified optical signal outputs and provide the attenuated or amplified optical signal outputs to an analog to digital converter (ADC).

6. The apparatus of claim 3, wherein each 2×2 unitary optical matrix comprises a weight to be applied in the ONN and wherein each of the phase shifters of each 2×2 unitary optical matrix is tuned to assist in applying the weight.

7. The apparatus of claim 6, wherein the optical unitary matrix multiplier is to receive the weight from a digital analog converter (DAC).

8. A method for an optical neural network (ONN), comprising:
generating, by a plurality of light sources on a semiconductor substrate, an array of light signals;
modulating, by a plurality of optical modulators on the semiconductor substrate, data onto the array of light signals to generate an array of optical signal inputs;
receiving, by an optical unitary matrix multiplier on the semiconductor substrate, the array of optical signal inputs; and
performing, by the optical unitary matrix multiplier, a linear transformation on the array of optical signal inputs to transform the array of optical signal inputs into an array of optical signal outputs, wherein the semiconductor substrate is a single semiconductor substrate including the plurality of light sources, optical unitary matrix multiplier, and optical unitary matrix multiplier.

9. The method of claim 8, wherein the performing, by the optical unitary matrix multiplier, the linear transformation includes performing the linear transformation using a plurality of optically interconnected 2×2 unitary optical matrices, wherein each optically interconnected 2×2 unitary optical matrix comprises a plurality of phase shifters to phase shift one or more of the optical signal inputs.

10. The method of claim 9, wherein the plurality of 2×2 unitary optical matrices include 2×2 unitary directional optical couplers or 2×2 unitary multi-mode interference (MMI) optical couplers.

11. The method of claim 10, wherein modulating, by the plurality of optical modulators, the data includes encoding an N-dimensional input vector of inputs into an array of optical signal inputs.

12. The method of claim 8, further comprising receiving, by a non-linear device, the array of optical signals output from the optical unitary matrix multiplier and performing an optical nonlinear amplification or attenuation of optical signal outputs.

13. The method of claim 12, further comprising providing the amplified or attenuated optical signal outputs to an analog-to-digital converter (ADC).

14. A system, comprising:
an optical neural network (ONN) integrated circuit (IC), comprising:
an array of light sources in a semiconductor substrate to generate an array of light signals;
a plurality of optical modulators coupled to receive the array of light signals from the array of light sources in the semiconductor substrate and to modulate data onto the array of light signals to provide optical signal inputs to the optical unitary matrix multiplier; and
an optical unitary matrix multiplier optically coupled to the plurality of optical modulators in the semiconductor substrate to receive the array of optical signal inputs and to linearly transform the plurality of optical signal inputs into an array of optical signal outputs; and
a processor coupled to the ONN IC to provide the ONN with the data to modulate onto the array of optical signal inputs to be linearly transformed by the optical unitary matrix multiplier.

15. The system of claim 14, wherein the semiconductor substrate is a single semiconductor substrate and the array of light sources, the plurality of optical modulators, and the optical unitary matrix multiplier are monolithically integrated in the single semiconductor substrate.

16. The system of claim 14, wherein the optical unitary matrix multiplier comprises a plurality of 2×2 unitary optical matrices optically interconnected, wherein each 2×2 unitary optical matrix comprises a plurality of phase shifters to phase shift, split, or combine one or more of the optical signal inputs.

17. The system of claim 14, further comprising electronic circuitry coupled to the optical unitary matrix multiplier and including a memory device and control logic to form an ONN accelerator coupled to receive the data from the processor.

18. The system of claim 14, further comprising an array of non-linear optical amplifiers and attenuators integrated in the semiconductor substrate to receive the array of optical signal output from the optical unitary matrix multiplier to attenuate or amplify the optical signal outputs.

19. The system of claim 14, further comprising an array of photodetectors coupled to detect the attenuated or amplified optical signal outputs and provide the attenuated or amplified optical signal outputs to an analog to digital converter.

20. The system of claim 18, wherein the processor coupled to the ONN IC is included data center server computing device.
